(19) United States
(12) Patent Application Publication
(10) Pub. No.: US 2004/0251344 A1
(43) Pub. Date: Dec. 16, 2004

(54) Pressure sensing system

(75) Inventors: Larry L. Lutton, Burnsville, MN (US); Robert M. Bowman, Plymouth, MN (US)

Correspondence Address: PAULEY PETERSEN & ERICKSON, 2800 WEST HIGGINS ROAD, SUITE 365, HOFFMAN ESTATES, IL, 60195, US

(73) Assignee: Varidigm Corporation, Plymouth, MN

(21) Appl. No.: 10/771,882

(22) Filed: Feb. 4, 2004

Related U.S. Application Data
(60) Provisional application No. 60/445,964, filed on Feb. 7, 2003.

(51) Int. Cl. B02C 11/08

(52) U.S. Cl. 241/47

(57) ABSTRACT

A pressure sensor system suitable for HVAC airflow control applications includes a simple probe tube as a part of a simple probe tube assembly of economical design located in a low turbulence, high velocity airflow area, such as the bell-mouthed flow ring surrounding a blower motor, and has low parasitic effect on the airflow. In certain aspects of the invention the simple probe tube assembly is connected to one side of an economical differential pressure sensor transducer which can be used to monitor airflow, either directly, or in conjunction with other data, in order to control the airflow of the HVAC application. The pressure sensor system is easily retrofitted to existing HVAC applications and does not cause significant airflow restriction as may result from pitot tube or orifice plate measuring devices.

This application claims priority from U.S. provisional patent application Ser. No. 60/445,964, filed 7 Feb. 2003.

### BACKGROUND OF THE INVENTION

Airflow control is used in many different types of HVAC systems. Airflow measurement in HVAC equipment is commonly done using various types of mechanical airflow sensors installed in the air stream. Typical examples of these mechanical sensors are pitot tubes, differential pressure measured across an orifice plate, or other types of sensors mounted in the air stream that behave like pitot tubes, i.e., devices to measure the flow velocity. Often these known devices may be expensive or may induce parasitic losses to the airflow. Some known methods may indirectly measure airflow and thus require more control apparatus and thus be just as costly or more costly than expensive direct flow measurement systems.

What is needed is a sensor device or system for measuring airflow in an HVAC system which can be readily fabricated at minimum cost while maintaining effective control of the airflow requirements of the HVAC system. It is further desirable that such a sensor device be easily retrofitted to existing HVAC systems. It is further desirable that such a sensor device minimize parasitic losses to the flow of air measured and thus not increase the power required to move the air in the HVAC systems.

### SUMMARY OF THE INVENTION

The present invention provides a pressure sensor system suitable for HVAC airflow control applications. “Pressure” as used herein can refer to either of a positive or negative (vacuum) pressure. Aspects of the invention include a simple probe tube assembly of economical design which is suitably located in a low turbulence, high airflow area, such as the bell-mouthed flow ring surrounding a blower motor. The simple probe tube assembly produces little parasitic effect on the airflow. In certain aspects of the invention the simple probe tube assembly is connected to one side of an economical differential pressure sensor transducer which can be used to monitor airflow, either directly, or in conjunction with other data, in order to control the airflow of the HVAC application. The pressure sensor system is easily retrofitted to existing HVAC applications, and with a motor speed controller, can be used in motorized equipment including but not limited to furnace fans, fan filter units, variable air volume boxes, exhaust fans, and squirrel cage blowers.

The sensor of the present invention can be readily fabricated at minimum cost. The simple probe tube assembly acts as the operative end of the sensor in the airflow to be sensed. “The simple probe tube assembly” is so-called because it has a simple tube, i.e., a tube with an unembellished substantially cylindrical structure having no significant bends or structural requirements such as in a pitot tube.

The simple probe tube assembly of the sensor is readily mounted at a point of low turbulence airflow that will desirably yield the highest possible signal to the transducer without the need for orifice plates or other means that might induce parasitic losses in the airflow. The simple probe tube assembly can be economically manufactured as an assembly including a probe end for placement in areas such as a bell mouth flow ring with mounting means. The simple probe tube assembly is located where the flow ring typically has the area of greatest restriction and therefore highest airflow in HVAC airflow system. The flow ring is typically a bell mouth flow ring. The point of lowest turbulence is then preferably selected for placement of the simple probe tube assembly in order to achieve minimal disruption to the smooth tracking of the transducer output. Further connecting tubing may then be used to connect the probe end to the transducer. Since there is no steady state flow through the tube, the tubing from the high flow area to the transducer can be minimally sized. Because the simple probe tube assembly of the present invention typically is placed in an area where a very high-pressure signal exists, the pressure sensor can utilize less expensive (lower accuracy) electronic pressure transducers and still achieve suitable accuracy for air flow control.

### BRIEF DESCRIPTION OF THE DRAWINGS

These and other objects and features of this invention will be better understood from the following detailed description taken in conjunction with the drawings wherein:

FIG. 1 illustrates the simple probe tube assembly attachment to a bell-mouthed flow ring and sensor connections to a motor controller.

FIG. 2 illustrates placement of the simple probe tube assembly in a top view with respect to a bell-mouthed flow ring and a fan motor and housing.

FIG. 3 illustrates placement of the simple probe tube assembly in a side cut-away view with respect to a bell-mouthed flow ring and a fan motor and housing.

FIG. 4 illustrates a simple probe tube assembly and assembly construction with connector means in front view.

FIGS. 5 and 6 illustrate a simple probe tube assembly and assembly construction with connector means in top and side views, respectively.

FIG. 7 is a graph of airflow as measured by an Anemometer on the Y axis and Dynamic Pressure on the X axis.

### DETAILED DESCRIPTION OF THE PREFERRED EMBODIMENTS

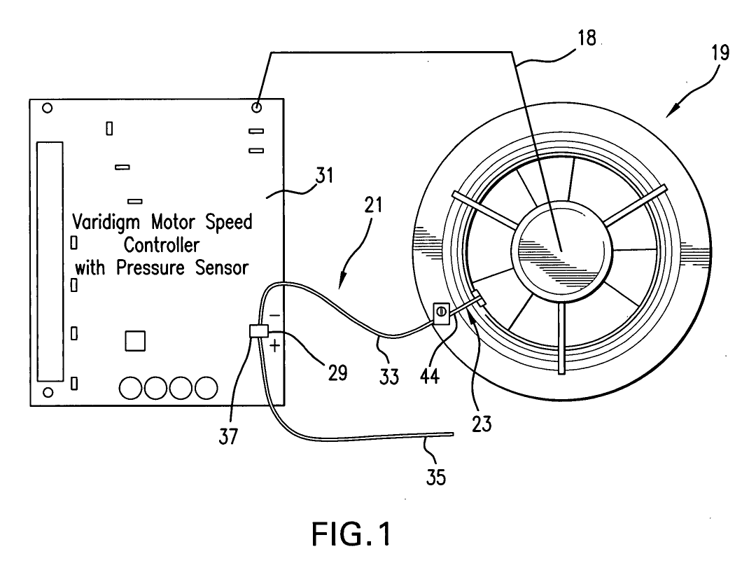

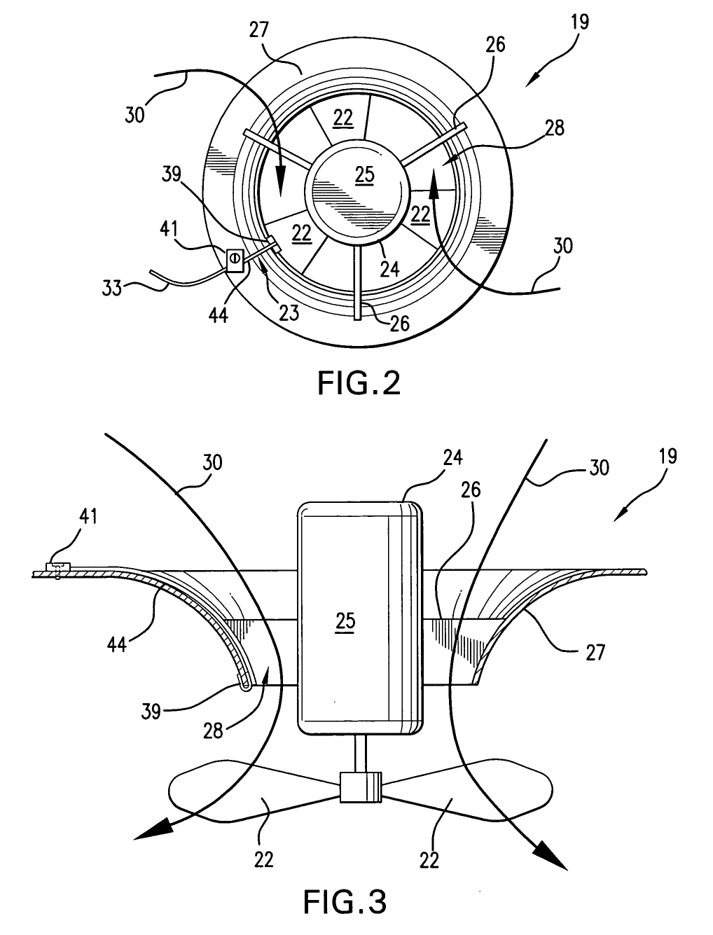

Referencing FIG. 1, the sensor 21 of the present invention is shown attached to blower assembly 19 and a motor speed controller 31. The motor speed controller 31 can control the airflow produced by blower assembly 19 through a control line 18. As further seen in the detailed drawings of FIGS. 2 and 3, the blower assembly 19 includes a flow director or ring 27, a motor 25 with a housing 24, and fan blades 22. The motor housing 24 is secured to the flow ring 27 with support vanes 26. The sensor transducer 29 is mounted to, and in electrical connection with, the motor speed controller 31 of the HVAC system.

A simple probe tube assembly 23, as further discussed below, mounts a simple probe tube 44 which communicates pressure to the transducer 29, shown here as a differential pressure sensor, through an additional connector tube 33 from the annular area of a bell-mouthed flow ring 27, to the pressure sensor 29. A reference pressure, e.g., entering duct pressure, can be connected by a second tubing 35 to the opposite, in this case, the positive, side 37 of the differential pressure sensor 29 so as to provide a signal that represents the differential pressure across the area 28 of the airflow path 30.

Aspects of this invention can take advantage of the unique construction of many of the fans used in the HVAC industry. By mounting the simple probe tube assembly 23, at the narrowest restriction in the flow path 30, in this instance the point of least diameter of the bell-mouthed flow ring, several advantages may be achieved. Because the measured airflow area 28 is defined by the narrowest area of the bell-mouthed flow ring 27, the simple probe tube assembly 23 is located at the point where the airflow area is at a minimum; hence the air velocity is at a maximum. Thus, this location can desirably yield the highest velocity and hence, the largest pressure signal possible. By measuring the high flow area, an economical transducer can be used, further decreasing the cost of a system according to the present invention. Care will be taken to determine a low turbulence area of airflow, desirably the least turbulent, in the high velocity stream in order to avoid effects which may disrupt the smoothness of the rise and fall of the output curve of the transducer signal.

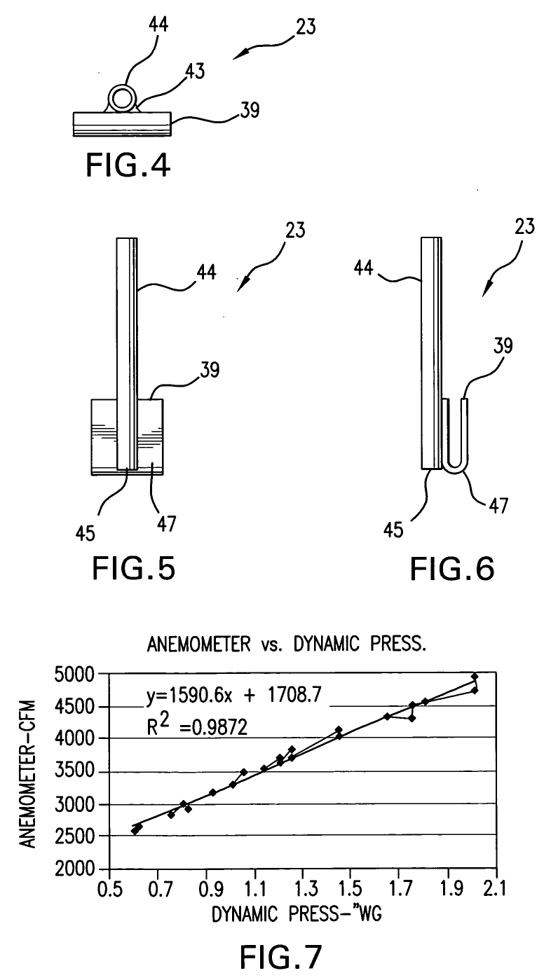

The simple probe tube assembly 23 may be fabricated for use as shown in FIGS. 4, 5 and 6. The simple probe tube assembly 23 desirably comprises copper tubing and metal fastener components for durability and rigidity although other materials may be used. Plastic tubing may be economically used, at least in part, for the connector tube 33 extending from the simple probe tube assembly 23 to the transducer 29.

A first end 45 of the tube 44 of the simple probe tube assembly 23 is attached in any desired manner, e.g., brazing 43, adhesives, or the like, to a U-shaped clip 39. The tube 44 is a simple tube which is so-called because it is a tube with an unembellished substantially cylindrical structure having no significant bends or structural requirements such as in a pitot tube. The clip 39 and tube 44 are preferably joined such that the edge of the tube first end 45 is substantially in the same plane as the inside edge 47 of the U-shaped clip 39. The clip 39 and the tube 44 can be any size that works satisfactorily with a selected application. Since there is no steady state flow through the tube 44, the inside diameter of the tube 44 is of little consequence.

Also referencing FIGS. 2 and 3, in keeping with an easily retrofitted design philosophy, the simple probe tube assembly 23 of the sensor 21, can be placed on the interior or inside surface of the bell-mouthed flow ring 27 with the first end 45 of the tube 44 over the rim of the flow ring, i.e., at the narrowest diameter of the measured area 28. The simple probe tube assembly 23 is then pulled into place with the clip 39 surrounding the edge of the flow ring 27. The clip 39 is then firmly secured into position on the edge of the flow ring 27 thereby placing the forward edge 45 of the tube 44 at the highest airflow area 28. The edge of the flow ring 27 will generally have sufficiently low turbulence to render a smooth signal from the transducer 29. However, further care in selecting the low turbulence area may need to be taken in placing the simple probe tube assembly 23 where the duct work and hence the air flow entering the flow ring 27 are not aligned with the flow ring 27. Also, in some instances the support vanes 26 may cause varying areas of turbulence within the flow ring 27. The simple probe tube assembly tube 44 is then typically clamped to an outer area of the flow ring 27 with a tubing clamp 41 for additional mechanical support. Additional tubing 33 may then be fitted over, or to, the simple probe tube assembly tube 44 and connected to the transducer 29.

Since airflow is the product of some constant K times the flow area in square feet (Ft²) and times the velocity in feet per minute (Ft/Minute), it follows that the airflow can be measured and controlled by means of the pressure sensor 21. Thus, the pressure sensor 21 of the present invention effectively obtains a measure of the air velocity. It also follows that by implementing a system to maintain a fixed setting of the pressure measured by this pressure/airflow sensor, the total airflow though the annular area can be controlled. As shown in the graph of FIG. 7, there is a very clear and almost linear correlation between the actual airflow (CFM as measured by Anemometer) vs. the dynamic pressure as measured by the pressure sensor 21.

The pressure measuring system of the present invention can be used in conjunction with a variable speed motor controller, e.g., from the family of Variable Speed Motor Controllers from Varidigm Corp. of Plymouth Minn. The pressure measuring system can be used to control airflow directly from the pressure reading or in conjunction with other data such as motor speed RPM data, as taught by U.S. patent application Ser. No. 10/191,975, filed 9 Jul. 2002, which is incorporated herein by reference in its entirety.

While an exemplary embodiment of the invention has been illustrated herein various aspects of the invention may be tested in various types of HVAC equipment in order to further optimize the mounting location of the simple probe tube assembly 23 in low turbulence, high velocity airflow in order to achieve the maximum consistent and smoothly varying signal in the selected applications; and optimize the diameter of the simple probe tube assembly tube 44 so as to reduce it to the smallest practical size to minimize the effect on the airflow.

Therefore, while in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A pressure sensor system suitable for HVAC airflow control applications comprising:
a) a simple probe tube located in an area of low turbulence, high velocity airflow of the HVAC airflow;
b) the simple probe tube connected to a pressure sensor transducer; and
c) whereby the signal from the transducer can be used to monitor the airflow of the HVAC application.

2. The pressure sensor system of claim 1 wherein the pressure sensor transducer is connected to a variable speed motor controller for monitoring and controlling the HVAC airflow.

3. The pressure sensor system of claim 1 wherein the variable speed motor controller is connected to a blower motor for controlling the HVAC airflow.

4. The pressure sensor system of claim 1 wherein the low turbulence, high velocity airflow area is a flow ring surrounding a blower motor.

5. The pressure sensor system of claim 4 wherein the blower motor is a variable speed blower motor.

6. The pressure sensor system of claim 1 wherein the pressure sensor transducer is a differential pressure sensor.

7. The pressure sensor system of claim 6 wherein the pressure sensor transducer is an electronic pressure sensor.

8. The pressure sensor system of claim 1 wherein the pressure sensor transducer is an electronic pressure sensor.

9. The pressure sensor system of claim 6 further comprising a second tube connected at a second side of the pressure sensor for a reference pressure.

10. The pressure sensor system of claim 4 wherein the simple probe tube is part of an assembly comprising a clip for attachment of the simple probe tube to an inside surface of the flow ring.

11. The pressure sensor system of claim 2 wherein the HVAC airflow is monitored and controlled directly from the pressure sensor transducer.

12. The pressure sensor system of claim 2 wherein the HVAC airflow is monitored and controlled from the pressure sensor transducer and in conjunction with other data.

13. The pressure sensor system of claim 4 wherein the flow ring has the highest velocity in the HVAC airflow.
